(19) United States
(12) Patent Application Publication
(10) Pub. No.: US 2003/0037176 A1
(43) Pub. Date: Feb. 20, 2003

(54) Method, apparatus and software program for message transmission between telecommunications network elements

(76) Inventors: Boris Dannehr, Isenbuettel, DE (US); Martin Wuschke, Meine (DE); Andreas Schmidt, Braunschweig (DE)

Correspondence Address: BELL, BOYD & LLOYD, LLC, P. O. BOX 1135, CHICAGO, IL, 60690-1135, US

(21) Appl. No.: 10/192,355

(22) Filed: Jul. 10, 2002

(30) Foreign Application Priority Data
Jul. 10, 2001 (DE) 101 334 72.9

(51) Int. Cl. G06F 17/60; G06F 9/46

(52) U.S. Cl. 709/313; 705/39; 709/246

(57) ABSTRACT

A method, apparatus and software program are provided for message transmission between telecommunications network elements which are involved in MMS (Multimedia Service) services, which are distinguished in that messages are sent from an MMS relay to an SCP/CSE (Service Control Point/CAMEL Service Environment), and/or vice versa, via an interface (Ge*) using a CAP (CAMEL Application Part) protocol.

### BACKGROUND OF THE INVENTION

The present invention relates to a method, apparatus and software program for message transmission between telecommunications network elements which are involved in MMS (Multimedia Messaging Service) services.

In mobile radio technology, provision is made for using “Multimedia Messaging Service” (MMS) services to develop new opportunities for providing and transferring data. MMS contents include one or more elements, such as text, speech, images and video. More precise details in this regard can be found in the publications by 3GPP (3^{rd} Generation Partnership Project) and ETSI (European Telecommunications Standards Institute), whose contents, like those of the other documents cited below too, are hereby explicitly incorporated in the disclosure. With regard to the implementation of Multimedia Messaging Service services, reference is made by way of example to 3GPP TS 22.140 V4.0.1 and 3GPP TS 23.140 V4.1.0.

The cited specifications demand online charging for MMS; i.e., implementation of billing options for the use of the MMS services. For this purpose, charging data records are produced in various network elements involved, particularly in the MMS relay, which is connected to an MMS server. The MMS server is responsible for temporarily storing and handling messages, while the MMS relay mediates between the MMS server and the respective user (User Agent) and thus permits, inter alia, the integration of various server types in various networks. The way in which it might be possible to implement such online charging is not described in the cited specifications, however. Likewise, it has not been possible, to date, to control the sending of MMs (Multimedia Messages) easily on the basis of the user's budget which is still available. In general, the simple provision of subscriber information is still a largely unsolved problem.

It is an object of the present invention to eliminate the aforementioned problems in the prior art and, in particular, to permit charge recording or online charging for MMS in a simple manner.

### SUMMARY OF THE INVENTION

This object is achieved for the method of the type mentioned in the introduction by virtue of messages being sent from an MMS relay to an SCP/CSE (Service Control Point/CAMEL Service Environment), and/or vice versa, via an interface using a CAP (CAMEL Application Part) protocol.

In addition, this object is achieved for an MMS relay via processing, receiving and/or sending messages from or to an SCP/CSE. For an SCP/CSE, this object is achieved via processing, receiving and/or transmitting messages from or to an MMS relay.

The present invention, which can be used for GPRS and UMTS services, in particular, is based on linking the MMS relay associated with the respective subscriber to the SCP (Service Control Point)/CSE (CAMEL Service Environment) using a CAP protocol (CAMEL Application Part). SCPs are databases which provide information concerning advanced call-processing options and which control service provision for a subscriber (customer, subscriber). CAMEL (Customised Applications for Mobile Network Enhanced Logic) is a network-based tool which helps the network operator to provide the customer (subscriber) with operator-specific services. This is also possible, in particular, when these subscribers are outside the HPLMN (Home Public Land Mobile Network) (roaming). Thus, CAMEL permits, by way of example, world-wide access to operator-specific intelligent network applications, such as prepaid and supervision. If a customer (subscriber) requires CAMEL support, the procedures which notify the VPLMN (Visited PLMN) and the HPLMN of the necessary information are called, in particular.

To introduce CAMEL, the CAP (CAMEL Application Part), including a CSE (Camel Service Environment) and a CCS7 (Common Control Signalling System 7, SS7), is required. SS7 is an architecture for information interchange between telephone networks, particularly for implementing out-of-band signalling to support, by way of example, call implementation, accounting and routing.

The fundamental concept of the present invention is, thus, that of implementing communication between the MMS relay and the SCP/CSE using a CAMEL protocol stack. To this end, an SSF (Service Switching Function) which is matched to the MMS relay and undertakes communication with the SCP/CSE is implemented on the MMS relay. This SSF is subsequently denoted by mmsSSF in order to illustrate the association with the CAMEL service. Via of this refinement, it is possible, in particular, for the MMS relay to request data and/or commands from the SCP/CSE in question in order for the MM and/or related data then to be handled and processed as appropriate, or for such actions to be conveyed; e.g., for the purpose of charging. Examples in this regard are given further below. In comparison with the prior art (i.e., linking the SCP/CSE to an SGSN (Serving GPRS Support Node) or to an HLR (Home Location Register)), there is the advantage of direct communication for user-specific data by the MMS relay from the SCP/CSE.

When the MMS relay has made contact with the SCP/CSE, the SCP/CSE preferably undertakes logic control. The SCP/CSE thus preferably makes decisions about the handling of the MMs and sends instructions to the MMS relay about the handling of the MMs. In this case, the mmsSSF becomes the “executive organ”.

The principle presented is a logical development of the already existing online charging method for circuit switched or packet switched data transfer and SMS. It easily can be incorporated into already existing PLMN network structures. The necessary protocol extensions at the SCP end and the introduction of an mmsSSF can be implemented without any great complexity.

A fundamental advantage of implementing the mmsSSF in the MMS relay is the opportunity for “content charging”. To this end, the SCP is notified of the MMS type (e.g., MP3, MPEG4, WAV, JPEG, . . . ). SCP can charge for the MM on the basis of the transmitted MMS type. In addition, the link to the SCP/CSE via CAMEL protocol allows roaming to other network operators.

In one preferred embodiment of the present invention, the CAP protocol to be used between the MMS relay and the SCP/CSE is based on the aforementioned signalling system No. 7 (SS7). It is thus possible to use the SS7 architecture which is already available anyway.

Alternatively, the CAP protocol to be used is based on an IP protocol stack which is required for the HLR link using an MAP (Mobile Application Part) protocol. MAP/CAP (Phase 4) over IP is still in the standardization phase, but will presumably be adopted for Release 4 (the name “Release 2000” is no longer used; Rel. 4 is identical to Rel. 2000, however). Since the PDN (Public Data Network) structure is based on IP, and the standardization for the future of the PLMN (Public Land Mobile Network) likewise propagates extensive use of IP, an IP-based protocol stack is a particularly preferred embodiment of the present invention. This procedure also has the advantage that it is not necessary to implement an additional protocol stack in the MMS relay.

So that the SCP/CSE can be usefully requested by the MMS relay, it is expedient that the MMS relay knows which CAMEL services are available to the subscriber. This information advantageously is stored in the subscriber's HLR and is requested by the subscriber's MMS relay. Upon the MMS relay's request to the HLR, an MMS-CSI (CAMEL Subscription Information) is then transmitted which contains subscriber information. An MMS-CSI is preferably allocated for sent (O-MMS-CSI) and received (T-MMS-CSI) MMs. On the basis of this MMS-CSI, the MMS relay is able to identify which CAMEL MMS service(s) are of use to the subscriber. Such a service can, by way of example, be prepaid use. On the basis of this information, the MMS relay can then ask the CSP/CSE for details regarding this service. In the case of the cited prepaid service, this might be the subscriber's budget which is still available, for example.

The present invention can be used, in particular, for performing the respective method steps for network nodes or network elements of the MMS-relay and SCP/CSE type. The implementation is effected by corresponding software programs also covered by the present invention which are able to be loaded onto the cited apparatuses as appropriate and/or can run thereon.

Additional features and advantages of the present invention are described in, and will be apparent from, the following detailed description of the invention and the Figures.

### BRIEF DESCRIPTION OF THE FIGURES

FIG. 1 shows a telecommunications network architecture with an MMS relay linked to an SCP/CSE via CAP protocol.

FIG. 2 shows a possible command set between an MMS relay and an SCP/CSE.

FIG. 3 shows command interchange between an MMS relay and an SCP/CSE for successful charging.

FIG. 4 shows command interchange between an MMS relay and an SCP/CSE when a budget is too low.

### DETAILED DESCRIPTION OF THE INVENTION

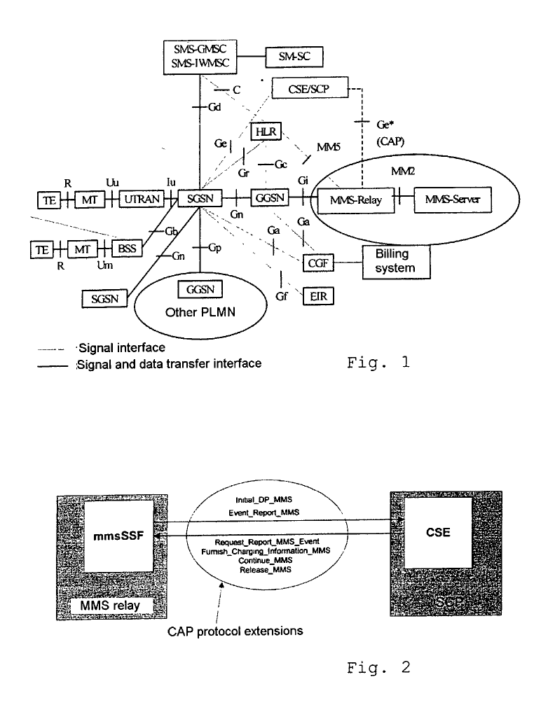

FIG. 1 shows the network architecture for packet switched data services and the linking of an MMS relay, as is prior art in many respects. However, the present invention is not limited to packet switched data services, but rather also can be used for circuit switched data services, for example. In particular, the present invention can be used for GPRS and UMTS. The network structure shown in FIG. 1 corresponds essentially to the architecture as known from FIG. 2 of 3G TS23.060, for example. Merely an excerpt from this architecture is meaningful for explaining the present invention. For further details, reference is made to the above source and to the specifications ETSI GSM 12.15 V6.2.0 and ETSI TS 32015 V3.4.0.

In a part referred to as a mobile termination MT, a terminal device contains all the functions required for radio transmission, and additionally the subscriber interface on the terminal TE, which subscriber interface is used to implement end-to-end connections between applications. R denotes a reference point between a non-ISDN-compatible TE and an MT. A reference point Uu connects the MT to an access network to allow access to the UMTS network. The access network, also called AND (Access Network Domain), can be implemented either by a UTRAN (UMTS Terrestrial Radio Access Network) or by a GSM-BSS (Global System for Mobile Communication-Base Station (Sub)System), as shown in FIG. 1. An MT can be connected to the Core Network Domain via the UTRAN using an “Iu interface” or via the BSS using an interface Gb.

The Core Network Domain is essentially implemented using two network nodes. These are firstly the SGSN (Serving GPRS Support Node) and secondly the GGSN (Gateway GPRS Support Node). Thus, the SGSN can support GPRS both for GSM and UMTS. The SGSN and the GGSN are connected to one another via an interface Gn. As indicated in the bottom part of FIG. 1, the SGSN can communicate with further SGSNs or GGSNs in other networks (“other PLMN”, Public Land Mobile Network).

The GGSN can use an interface Gi to connect to an MMS relay, which is connected to an MMS server (Multimedia Messaging Service server) via an interface MM2. The MMS relay and the MMS server are part of a PDN (Public Data Network).

A “Home Location Register” (HLR) normally contains Packet Domain (PD) data in line with the individual data for individual subscribers and routing information. In this context, the HLR can be accessed, inter alia, by the SGSN via a “Gr interface”, by the GGSN via an “Gc interface”, and by an MMS relay via an “MM5 interface”.

Provision is made for the HLR functionality of today's PLMN networks to be undertaken or complemented by an HSS (Home Subscriber Server). The corresponding protocols and interfaces then need to be matched thereto. Although the present invention is explained below with reference to the use of an HLR, there are no fundamental differences with respect to the use of an HSS.

Charging data records containing information about the services used (see ETSI GSM 12.15 V6.2.0 and ETSI TS 132015 V3.4.0, for example) are created by the SGSN and GGSN and are transferred to a billing system (BS) associated with the network operator. Charging information is preferably collected for every mobile station by the SGSNs and GGSNs which serve this mobile station. For each MS, the SGSN collects charging information which is associated with the use of the radio network, while, for each mobile station, the GGSN collects charging information which is associated with the use of the external data network. The interface between the GPRS and the external packet data network is denoted by Gi. In addition, both nodes, SGSN and GGSN, collect subscriber-related charging information concerning the use of GPRS network resources. The elements of the multimedia messaging service (MMS) also have provision for CDRs to be produced. The option of producing CDRs in an MMS relay is described in 3G TS22.140V4.0.1 (§8) and in 3G TS23.140V4.1.0 (§5.3).

An SCP (Switching Control Point) with a CSE (CAMEL Service Environment) stores user-specific data; e.g., information about the level of credit of a subscriber to a prepaid service. For data transfer to other network elements, a “CAMEL” (Customized Applications for Mobile Network Enhanced Logic) architecture or a CAP protocol (CAMEL Application Part) is used.

The flow of information between SGSN and SCP/CSE is preferably initialized as follows: the SGSN receives from the HLR information about the availability of a specific service. By way of example, the HLR transmits confirmation or rejection regarding the subscriber's use authorization to the SGSN, where a check is carried out to determine whether the user actually has authorization to send outgoing multimedia messages (“subscription check”). Equally, the HLR can store whether the subscriber is a prepaid user. This information is forwarded to the SGSN via an interface Gr. The SGSN can then be informed about the subscriber's credit, for example, by the SCP/CSE via an interface Ge and can accordingly prompt or prevent forwarding of an MM to the GGSN.

In accordance with the present invention, data transfer is now possible for communication between the MMS relay and the CSP/CSE. To this end, a new interface is required, which will be denoted by Ge* in the present case. Communication via this interface is, likewise, effected using a CAP protocol.

In accordance with the present invention, an SS7 already demanded in the MMS relay for the HLR link, or alternatively an IP protocol stack, is used and a CAMEL protocol based thereon is extended for MMS-specific messages (operations). To handle these messages, an mmsSSF is expediently introduced in the MMS relay. An already existing gsmSCF in the SCP/CSE needs to be extended by the appropriate messages. So that the MMS relay can identify whether the subscriber is a prepaid subscriber, for example, the MMS relay requests subscriber information from the HLR. This subscriber information needs to be extended by an “MMS-CSI” (CAMEL Subscriber Information). The difference with respect to the prior art is that not only the SGSN is able to receive information from the SCP/CSE, but also the MMS relay. This allows the MMS relay to transmit charge-related data, in particular, to the SCP/CSE, which processes the charge-related data and, if appropriate, returns a message to the MMS relay. Equally, “content charging” can be implemented in the SCP/CSE. In this context, the SCP/CSE receives from the MMS relay information about the transmitted MMS type and the size of the MMS (e.g. MP3 file with a size of 3 Mbytes). In this case, the type and size determine the level of charges which are billed to the subscriber and need to be deducted from his/her account. In addition, the use of the CAP protocol likewise allows roaming.

In accordance with FIG. 2, one or more of the messages below are advantageously added to the CAMEL standard (3GPP TS 23.078, 3GPP TS 29.078) for the purpose of MMS online charging. In this context, the names are chosen expediently and are by no means absolute.

Initial_DP_MMS (From the MMS Relay to the SCP/CSE)

The message is produced in the MMS relay and is sent to the gsmSCF if the mmsSSF, which is in the MMS relay, has identified an MM from a prepaid subscriber. This message is used to notify the SCP/CSE of charge-related information, such as MMS volume (kbytes), a timestamp and the MMS type (see 23.240v410 §5.1.2). Transmission of the MMS type allows the SCP/CSE to implement content charging. The MMS relay now waits for further instructions from the SCP/CSE.

Request_Report_MMS_Event (From the SCP/CSE to the MMS Relay)

The SCP/CSE can use this message to request the report about further events. This can include successful delivery of the MM to the receiver or successful storage of the MM in the MMS server.

Event_Report_MMS (From the MMS Relay to the SCP/CSE)

This message is used to inform the SCP/CSE about the occurrence of an event. One possible event is the successful or incorrect delivery or storage of an MM to or in the UE/MMS server. By requesting these events, it is possible to ensure that the prepaid subscriber is not charged for any MMs which it has not been possible to deliver, for example on account of network problems (PLMN, PDN).

Furnish_Charging_Information_MMS (From the SCP/CSE to the MMS Relay)

The SCP/CSE can use this message to store further supplementary information in the charging data records (CDR). It is possible to send a number of FCIs (Furnish Charging Information) having a maximum length of 160 octets. This description follows the existing SMS specification in 3GPP TS 23.078 §7.6.2.3.

Continue_MMS (From the SCP/CSE to the MMS Relay)

The charging information transmitted by the MMS relay is used to charge for the MM from the prepaid subscriber, and his/her existing budget is thus reduced. The message Continue_MMS is used to permit the MMS relay to deliver the MM. The message Continue_MMS is used generally to notify an SSF that it can continue its processing. This applies to the “Event” and “Trigger Detection Points” which have been “armed” in the request mode, see (Request Modes, see 3GPP TS 23.078).

Release_MMS (From the SCP/CSE to the MMS Relay)

If the SCP/CSE has established from the transmitted charging information that the budget available on the SCP/CSE is no longer sufficient to deliver the MM, the message Release_MMS is used to notify the MMS relay that the message cannot be delivered.

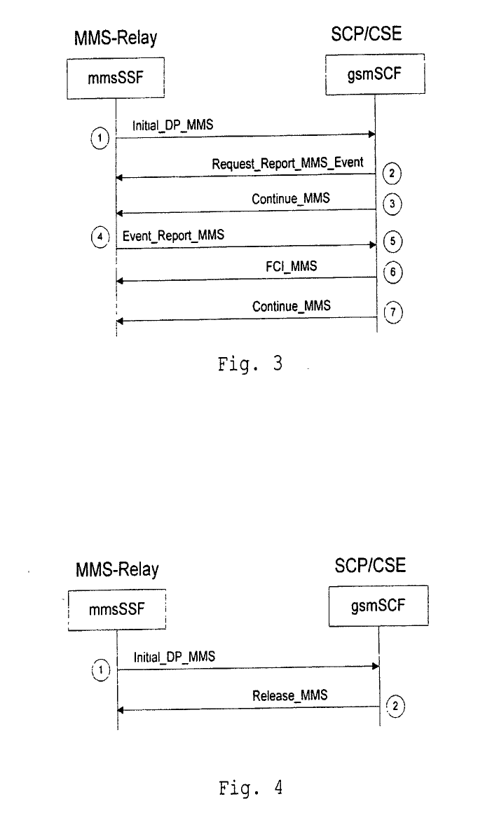

FIGS. 3 and 4 are used to explain two corresponding examples in more detail.

FIG. 3 shows the message interchange between an MMS relay and an SCP/CSE for successful charging for an MM. The following message cycle or operation cycle is advantageously performed in line with FIG. 3 for successful charging:

1. The MMS relay establishes that a prepaid subscriber wishes to send an MM. Delivery of the MM is interrupted. The MMS relay sets up a connection to the SCP/CSE and uses the operation Initial_PD_MMS to request further instructions from the SCP/CSE.

2. The SCP/CSE can now optionally use the operation Request_Report_MMS_Event to request notification about particular events (“Event Detection Points”). In this case, by way of example, confirmation of successful storage of the MM on the MMS server can be requested. Instead of the request mode (see 3GPP TS 23.078), it is also possible to transfer event announcements from the MMS relay to the SCP/CSE without any special request.

3. The operation Continue_MMS is used to notify the mmsSSF/MMS server that sufficient budget is available to charge for this MM, and that the MM can be delivered.

4. The MMS relay uses the operation Event_Report_MMS to confirm successful storage of the MM on an MMS server, for example.

5. The prepaid subscriber is now charged for the delivery of an MM on the SCP/CSE.

6. The SCP/CSE uses the operation FCI_MMS optionally to send the mmsSSF charging information which additionally needs to be entered into the MMS relay's CDR (charging ticket or charging data record).

7. The operation Continue_MMS is used to notify the mmsSSF that it can continue processing (only in the request mode) and that the SS7/IP connection to the SCP/CSE needs to be cleared down.

FIG. 4 shows the messages and operations interchanged between the MMS relay and the SCP/CSE for the case of an MM being rejected on account of too little a budget.

1. The MMS relay establishes that a prepaid subscriber wishes to send an MM. Delivery of the MM is interrupted. The MMS relay sets up a connection to the SCP/CSE and uses the operation Initial_PD_MMS to request further instructions from the SCP.

2. The SCP/CSE establishes that the prepaid subscriber's budget has been used up. The operation Release_MMS is used to notify the mmsSSF that it needs to reject the request to deliver this MM.

The present invention can be used both for outgoing (originated) and for incoming (terminated) MMs. In the first case, the sender's MMS relay communicates with his/her SCP/CSE; in the second case, the receiver's MMS relay communicates with the corresponding SCP/CSE. The two MMS relays of the sender and of the receiver and/or the two SCP/CSEs also can be identical.

With regard to the apparatuses, the present invention includes, in particular, provision of the necessary parts for receiving, processing and/or sending the messages. This requires provision of appropriate processor parts and also transmission and/or reception apparatuses; in general terms, communications devices.

The network components described and claimed, including the interfaces, protocols and connections to one another, are also to be understood to include those future developments which essentially will have the same tasks as those described in the present case.

Although the present invention has been described with reference to specific embodiments, those of skill in art will recognize that changes may be made thereto without departing from the spirit and scope of the present invention as set forth in the hereafter appended claims.

1. A method for message transmission between telecommunications network elements which are involved in MMS services, comprising transmitting messages between an MMS relay and an SCP/CSE via an interface using a CAP protocol.

2. The method for message transmission between telecommunications network elements as claimed in claim 1, wherein the message transmission is effected using an SSF implemented in the MMS relay.

3. The method for message transmission between telecommunications network elements as claimed in claim 1, wherein the message transmission is effected using an SCF implemented in the SCP/CSE.

4. The method for message transmission between telecommunications network elements as claimed claim 1, wherein the CAP protocol is based on SS7.

5. The method for message transmission between telecommunications network elements as claimed in claim 1, wherein the CAP protocol is based on an IP protocol stack.

6. The method for message transmission between telecommunications network elements as claimed 1, the method further comprising the step of requesting, via the MMS relay, corresponding MMS-CSI from one of an HLR and an HSS for CAMEL MMS services available to a subscriber.

7. The method as for message transmission between telecommunications network elements as claimed in claim 1, the method further comprising the step of receiving, via the MMS relay, corresponding MMS-CSI from one of an HLR and an HSS for CAMEL MSS services available to a subscriber.

8. The method for message transmission between telecommunications network elements as claimed in claim 6, wherein the MMS relay requests MMS-CSI for one of sent MMs and received MMs.

9. A method for message transmission between telecommunications network elements as claimed in claim 7, wherein the MMS relay receives MMS-CSI for one of sent MMs and received MMs.

10. A method for message transmission between telecommunications network elements as claimed in claim 1, wherein, when the MMS relay makes contact with the SCP/CSE, the SCP/CSE undertakes logic control and sends instructions to the MMS relay about handling of an MM.

11. A method for message transmission between telecommunications network elements as claimed in claim 1, wherein the MMS relay transmits to the SCP/CSE at least one of charge-related information and events concerning processing of an MM.

12. A method for message transmission between telecommunications network elements as claimed in claim 1, wherein the SCP/CSE transmits to the MMS relay at least one of requests to the MMS relay for transmission of particular events, supplementary information relating to storage in charging data records in the MMS relay, permission to deliver an MM and notification that an MM is not to be delivered.

13. A method for message transmission between telecommunications network elements as claimed in claim 1, wherein the SCP charges a subscriber account based on use of an MMS service by at least one of an MM sender and an MM receiver.

14. A method for message transmission between telecommunications network elements as claimed in claim 1, wherein charging relates to at least one of a type and a scope of an MM.

15. An MMS relay, comprising parts for at least one of processing messages, receiving messages from and sending messages to an SCP/CSE.

16. A MMS relay as claimed in claim 15, wherein the MMS relay transmits to the SCP/CSE at least one of charge-related information and events concerning processing of an MM.

17. An MMS relay as claimed in claim 13, wherein an MMS SSF is implemented.

18. An MMs relay as claimed in claim 15, further comprising parts for communicating with the SCP/CSE using a SAP protocol which is based on one of an SS7 protocol and an IP protocol stack which is also used for one of an HLR and an HSS link using a MAP protocol.

19. An MMS relay as claimed in claim 15, further comprising parts for at least one requesting, receiving and processing MMS-SCI from one of an HLR and an HSS via an interface.

20. An SCP/CSE, comprising parts for at least one of processing messages, receiving messages from and sending messages to an MMS relay.

21. An SCP/CSE as claimed in claim 20, wherein the SCP/CSE transmits to the MMS relay at least one of a request to the MMS relay for transmission of particular events, supplementary information relating to storage in charging data records in the MMS relay, permission to deliver an MM and notification that an MM is not to be delivered.

22. An SCP/CSE as claimed in claim 20, wherein a GSM SCF is implemented.

23. An SCP/CSE as claimed in claim 20, further comprising parts for communicating with the MMS relay using a CAP protocol which is based on one of an SS7 protocol and an IP protocol stack which is also used for one of an HLR and HSS link using a MAP protocol.

24. A software program which can run on an apparatus, the apparatus being one of an MMS relay and an SCP/CSE, wherein the software program together with the apparatus effect a method for message transmission comprising transmitting messages between the MMS relay and the SCP/CSE via an interface using a CAP protocol.
